(19) United States
(12) Patent Application Publication
(10) Pub. No.: US 2014/0319951 A1
(43) Pub. Date: Oct. 30, 2014

(54) SLOTLESS AMORPHOUS FERROALLOY ELECTRIC MACHINE WITH RADIAL MAGNETIC CIRCUIT AND ITS MANUFACTURING METHOD

(71) Applicants: Wei Xie, Shenzahen (CN); Lei Shi, Shenzhen (CN)

(72) Inventors: Wei Xie, Shenzahen (CN); Lei Shi, Shenzhen (CN)

(73) Assignee: Shenzhen Hopewin Technology Co., Ltd.

(21) Appl. No.: 13/811,790

(22) PCT Filed: Dec. 6, 2010
(86) PCT No.: PCT/CN10/01969

§ 371 Date: May 5, 2014

(30) Foreign Application Priority Data
Jul. 26, 2010 (CN) 201010237537.1

(51) Int. Cl. H02K 1/27; H02K 15/02

(52) U.S. Cl. CPC H02K 1/27; H02K 15/02
USPC 310/156.78; 310/216.001; 310/156.01; 29/598

(57) ABSTRACT

A slotless amorphous ferroalloy electric machine with radial magnetic circuit and a manufacturing method. The invention includes a stator iron core (21), a cylinder formed by winding an amorphous ferroalloy strip, a stator winding (22) is integrally in the shape of a cylinder and fixed on the internal cylindrical surface of the stator iron core (21), connecting with a metal reinforcing sleeve (25). A radial air gap (5) is arranged between the internal cylindrical surface of the metal reinforcing sleeve (25) and the external surface of a rotor (3). A rotor iron core (31) having a hollow amorphous ferroalloy cylindrical structure and the inner bore wall of the rotor iron core (31) is provided with keyway (312) used for connecting with a electric machine shaft (6) that the radial external surface of the rotor iron core (31) matches with permanent magnets (32).

### TECHNICAL FIELD

The invention relates to the magnetic circuit components for electric machine manufacturing, especially to the stator or rotor body featured by armature winding and magnetic materials.

### BACKGROUND ART

The amorphous ferroalloy material is the material possessing long-range disordered structure, which is formed by active metal atoms under high temperature molten status failing to arrange orderly according to definite crystalline state rule during flash cooling. As compared with the traditional silicon steel material, the amorphous ferroalloy material has the advantages of high magnetic permeability, high resistance, low eddy current loss and superior high frequency characteristic, etc. Nevertheless, it is of poor processing characteristic, difficult to be rolled into sheets and difficult to be cut and processed with large sizes. As for the prior art, the electric machine includes the generator and the electromotor, comprising shell, end covers, stator, rotor and electric machine shaft. The stator is fixed on the inside of the shell. The rotor is fixed on the electric machine shaft and arranged inside the stator. An air gap is arranged between the rotor and the stator. The electric machine shaft passes through the stator iron core and is rotatably mounted onto the mounting position determined by the shell and the end covers. The stator is composed of the stator iron core and the stator winding. Generally, the stator iron core with axial tooth slots inside is made by pressing and laminating silicon steel stampings and other soft-magnetic materials, and the stator winding is embedded into the tooth slots. For electric machine loss, iron loss takes up a considerable proportion which consumes non-renewable energy in the form of emitting heat, in the meantime, increases the electric machine temperature rise and reduces the electric machine efficiency. It is a great project for electric machine design as concerning the reduction of electric machine iron loss, and it is one orientation for electric machine research and development as concerning the using of new materials of high magnetic permeability, high resistance and low eddy current loss to replace the silicon steel plates. Electric machines prepared from amorphous ferroalloy material is adopted for the prior art, for example, in the Chinese patent application New Type Motor Prepared from Amorphous Material with the publication number of CN 1874113A, a cylindrical amorphous shell and silicon steel plates poles are coupled and bonded to form the tooth slots for the stator iron core. Stator windings are embedded inside the tooth slots for preparing the stator. Amorphous material is used partially in the electric machine stator iron core. For the electric machine with the iron core made from mixed materials, the rotor is still of the traditional structure, whose stator iron core is the bonding of two components separately made from two materials. With complicated structure and elaboration process, moreover, the electromagnetic noise and tooth slot loss brought by the tooth slot effect are still not overcome. While, in the slotless electric machine for the purpose of overcoming the defects brought by the tooth slot effect, is adopted the technology disclosed in the patent for Utility Model titled High Output Brushless and Slotless Permanent Magnets Motor, whose publication number is CN2891450Y for example, in it the stator iron core is still made by laminating traditional silicon steel plates, and the rotor is composed of the iron core made from the traditional material and permanent magnet sheathed around the iron core. Inherent defects of the silicon steel plate concerning magnetic permeability, resistance, eddy current loss and high frequency characteristic, etc. enabling it to fail to produce electric machine of higher efficiency.

### CONTENTS OF THE INVENTION

The technical problem the invention aims to settle, lies in avoiding the above-mentioned deficiencies of prior art and providing a slotless amorphous ferroalloy electric machine with radial magnetic circuit. The electric machine has the advantages of low eddy current loss, superior high frequency characteristic, low electromagnetic noise, no tooth slot loss, high efficiency, high power density and high material utilization, etc. Meanwhile, the invention also provides the manufacturing method of the slotless amorphous ferroalloy electric machine with radial magnetic circuit.

Technical solution adopted by the invention so as to solve the said technical problems is that:

According to different forms of the rotor, inner rotor electric machine or outer rotor electric machine may be conceived for the invention.

When inner rotor electric machine is embodied for the invention, a slotless amorphous ferroalloy electric machine with radial magnetic circuit is provided, comprising: a shell, an end cover, a stator, a rotor and an electric machine shaft. The end cover is mounted to the end of the shell and determines the mounting position of the electric machine shaft together with the shell. The stator is fixedly mounted to the inside of the shell. The rotor is fixedly mounted on the electric machine shaft and arranged inside the stator. A radial air gap is arranged between the rotor and the stator. The electric machine shaft and the rotor thereon pass through the inner capacity cavity of the stator and rotatably mounted on the mounting position determined by the shell and the end cover. The stator includes the stator iron core and the stator winding. The said stator iron core is the cylinder formed by winding an amorphous ferroalloy strip. The said stator winding is integrally in the shape of a cylinder and fixed on the internal cylindrical surface of the stator iron core. A metal reinforcing sleeve is fixed on the internal wall of the stator winding. The axial length of the metal reinforcing sleeve is identical to that of the stator winding. A radial air gap is arranged between the internal cylindrical surface of the metal reinforcing sleeve and the external surface of the said rotor.

In the invention, the stator winding may be directly fixed on the internal wall of the said stator iron core, and the metal reinforcing sleeve may be fixed directly on the internal wall of the stator winding.

In the invention, internal wall of the said stator iron core may be installed with a first insulation bobbin. Main body of the first insulation bobbin is in the shape of a cylinder with one end surface set with a ring-shaped radial flange. One end which is not set with flange for the two identical first insulation bobbins respectively are embedded from both ends of the inner capacity cavity of the stator iron core, butted against each other and fixed on the internal wall of the stator iron core. The ring-shaped radial flanges at the end surfaces of the said two first insulation bobbins are tightened against both ends of the inner capacity cavity of the stator iron core.

In the invention, the inner cavity of the said stator winding is supported by a cylindrical second insulation bobbin and fixed therein. The axial length of the second insulation bobbin is identical to that of the stator winding. The internal wall of the said second insulation bobbin is fixed on the external cylindrical surface of the metal reinforcing sleeve.

Stability and insulation safety of the stator winding may be strengthened by the structures of various insulation bobbins.

Therefore, the stator winding “fixed on the internal cylindrical surface of the stator core” stated by the invention can either be the direct fixation of the stator winding onto the internal wall of the stator iron core, or the fixation of the stator winding on the internal wall of the first insulation bobbin, then the fixation of the first insulation bobbin on the internal wall of the stator iron core. The said “fixation” includes the fixation with adhesives. The adhesives for bonding and fixation may be any adhesive with the operating temperature no lower than the maximum temperature rise limited by the electric machine.

The slotless amorphous ferroalloy electric machine with radial magnetic circuit in the invention is the brushless DC electric machine or AC synchronous electric machine, including DC or AC electromotor and generator. Meanwhile, it may also be AC asynchronous electric machine.

The rotor stated by the invention includes the rotor iron core and the permanent magnets. The said rotor iron core may be made by laminating and pressing conventional material, for example the silicon steel stampings; or, the said rotor iron core is the hollow cylindrical structure made from amorphous ferroalloy material, with the radial external surface matched with the permanent magnets. The permanent magnets are embedded in or sheathed outside of the external surface of the rotor iron core and fixed. Keyway for connecting with the said electric machine shaft is provided on the inner bore wall of the said rotor iron core. The said permanent magnets are neodymium-iron-boron alloy of high density of magnetic energy, or the strontium or barium ferrite.

When the permanent magnets are hollow cylindrical permanent magnetic cylinders with multiple poles formed on the circumferential surface via magnetization, external surface of the rotor iron core is the cylinder, with the outer diameter matched with the inner diameter of cylinders of the permanent magnets. Cylinder of the said permanent magnets are directly sheathed on the rotor iron core and fixed.

When the permanent magnets are even-numbered tile-shape sectional bars or “V” shaped sectional bar solids, the same amount of axial grooves matched with the sectional forms of all the permanent magnets are provided on the external surface of the rotor iron core, and all the permanent magnets shall be embedded into the grooves and fixed. The said axial grooves may be dovetail grooves, and accordingly, the said permanent magnets are with dovetail structures.

When the invention is embodied in the AC asynchronous machine, the rotor as stated by the invention includes the rotor iron core and the squirrel-cage on the surface thereon. The rotor iron core is sheathed on the electric machine shaft. The said rotor cage is fixedly mounted on the external surface of the rotor iron core. The said rotor iron core may be prepared by laminating and pressing conventional materials, for example the silicon steel stampings. Or, the said rotor iron core is the hollow cylindrical structure made from amorphous ferroalloy material. The radial external surface of the rotor iron core is matched with the copper or aluminum bar shapes of the said squirrel-cage. The copper bars or aluminum bars are embedded in the external surface of the rotor iron core, and fixedly mounted by virtue of the copper or aluminum rings at both ends. Keyway for connecting with the said electric machine shaft is also provided on the inner bore wall of the said rotor iron core.

When the invention is embodied in the outer rotor electric machine, a slotless amorphous ferroalloy electric machine with radial magnetic circuit includes a stator, an outer rotor and an electric machine bearing shaft for mounting. The outer rotor is arranged outside the stator, comprising a shell, a left and right end cover and permanent magnets. The permanent magnets are fixed on the internal wall of the shell, the left and right end covers are fixedly mounted on the left and right end parts of the shell. The outer rotor is rotatably mounted on the electric machine bearing shaft. The stator is fixedly mounted on the electric machine bearing shaft, comprising a stator iron core and a stator winding. The said stator iron core is the hollow cylindrical structure made from amorphous ferroalloy material. The said stator winding is integrally in the shape of a cylinder and fixed on the external cylindrical surface of the stator iron core. There is a metal reinforcing sleeve on the radial external surface of the stator winding. A radial air gap is arranged between the external cylindrical surface of the metal reinforcing sleeve and the internal surface of the outer rotor. The permanent magnets are embedded in the internal surface of the shell in the form of even-numbered bar shapes, or directly fixed on the internal surface of the shell in the shape of hollow cylinders. The shell is formed by rolling a steel plate or directly made of a steel pipe.

Amorphous ferroalloy material used by the stator iron core of the invention is the commercially available section-bar formed by winding an amorphous ferroalloy strip.

The rotor iron core of the invention is made from the commercially available section bar blank formed by winding an amorphous ferroalloy strip via processing.

The section bar formed by winding the amorphous ferroalloy strip may be adopted simultaneously as the radial magnetic circuit blank for the electric machine stator and the rotor.

Accordingly, for the inner rotor electric machine, manufacturing method for the slotless amorphous ferroalloy electric machine with radial magnetic circuit is also provided, which includes the steps as follows:
a. Preparation: a hollow cylindrical section-bar formed by winding an amorphous ferroalloy strip is used to serve as the blank of the stator iron core and the rotor iron core;
b. Elaboration of stator: first, prepare the stator winding, then by means of trimming, the required shape and size of the stator winding are obtained. Now, choose to execute one of the following steps:
   b1. If a second insulation bobbin is installed for the stator winding, the second insulation bobbin shall be fixed on the internal cylindrical surface of the stator winding; then the metal reinforcing sleeve shall be fixed to the internal wall of the second insulation bobbin.
   b2. If a second insulation bobbin is not installed for the stator winding, then the internal cylindrical surface of the stator winding shall be fixed directly on the metal reinforcing sleeve.
   Besides, choose to execute one of the following steps again:
   b3. If there is a first insulation bobbin in the stator iron core, then the first insulation bobbin shall be fixed on the internal wall of the stator iron core, and the external cylindrical surface of the stator winding shall be fixed on the internal wall of the first insulation bobbin, thus, the elaboration of stator is completed.
   b4. If the first insulation bobbin is not installed for the stator iron core, then the stator winding shall be fixed directly on the internal wall of the stator iron core, thus, the elaboration of stator is completed.
c. Elaboration of rotor: keyway used for connecting with the electric machine shaft shall be processed on the inner bore wall of the hollow cylindrical section bar which is formed by winding an amorphous ferroalloy strip served as the blank of the rotor iron core, and choose to execute one of the following steps:
   c1. When the permanent magnets are hollow cylindrical permanent magnetic cylinder with multiple magnetic poles formed on the circumferential surface via magnetization, attributable to the external cylindrical surface of the section bar blank for the rotor iron core, the rotor iron core shall be embedded into the cylinder of the said permanent magnets directly and fixed, and then the rotor shall be assembled;
   c2. When the permanent magnets are even-numbered tile-shaped sectional bars or “V” shaped sectional bar solids, the same amount of axial grooves matched with the sectional forms of all the permanent magnets shall be provided on the external surface of the rotor iron core, and all the permanent magnets shall be embedded into the axial grooves and fixed. Then, the rotor shall be assembled.
   c3. When the rotor is of squirrel-cage structure, axial grooves which are matched with the axial copper or aluminum bar shapes of the said squirrel-cage shall be processed on the external surface of the rotor iron core. Copper or aluminum bars of the squirrel-cage are embedded on the external surface of the rotor iron core, fixedly mounted by virtue of the copper or aluminum rings at both ends.
d. Load the stator into the shell and sheath the rotor on the electric machine shaft as per the routine operations, thus, the elaboration of the two components is completed.
e. Complete machine assembly: finish complete machine assembly for the electric machine as per the routine operations.

For the outer rotor electric machine, manufacturing method for the slotless amorphous ferroalloy electric machine with radial magnetic circuit is also provided accordingly, which includes the steps as follows:
a. Preparation: a hollow cylindrical section bar formed by winding an amorphous ferroalloy strip is used to serve as the blank of the stator iron core;
b. Elaboration of stator: keyway used for connecting with the electric machine shaft shall be processed on the inner bore surface of the stator iron core, stator winding shall be prepared, then by means of trimming, the required shape and size of the stator winding are obtained. The external cylindrical surface of the stator winding shall be fixed directly into the metal reinforcing sleeve. The stator winding shall be sheathed and fixed on the external cylindrical surface of the stator iron core. The stator iron core and the electric machine shaft shall be connected and fixed with keys, and two bearings shall be mounted for the electric machine bearing shaft, thus the elaboration of stator is completed.
c. Elaboration of rotor: even-numbered bars or hollow cylindrical permanent magnets shall be made. Roll the steel plate into a shell or use the steel pipe directly as the shell. Shapes matched with the permanent magnets to be fixed shall be processed on the internal wall of the shell. Permanent magnets shall be embedded and fixed on the internal wall of the shell, and the rotor shall be assembled.
d. Finish complete machine assembly for the electric machine as per the routine operations.

As compared with the prior art, the beneficial effects of the slotless amorphous ferroalloy electric machine with radial magnetic circuit as well as the manufacturing method thereof are:

1. The adoption of the amorphous ferroalloy material as the radial magnetic circuit material for the stator of the electric machine, volume and loss of the electric machine are effectively reduced and efficiency is improved. Meanwhile, with the toothless and slotless design, processing difficulty of tooth slots is avoided, and man-hour is saved, and processing cost is greatly reduced, thus, cogging effect of the electric machine is avoided, electromagnetic noise is reduced and operation performance of the electric machine is improved.

2. Besides, amorphous ferroalloy material may be simultaneously adopted as the radial magnetic circuit material for the rotor of the electric machine, therefore, volume and loss of the electric machine are effectively reduced, and efficiency is improved.

3. With low eddy current loss, superior high frequency characteristic, low electromagnetic noise, high efficiency and power density, it is a electric machine of high efficiency and energy saving, whose mechano-electric efficiency may be improved from 95% of the traditional electric machine to 97% or even more, thus, the unexpected effect is achieved and commercial successes is easily attainable.

### DESCRIPTION OF FIGURES

FIG. 1 shows a longitudinal sectional schematic diagram for the orthographic projection of the integral structure concerning the preferable embodiment “A Slotless Amorphous Ferroalloy Electric Machine with Radial Magnetic Circuit and Its Manufacturing Method” for the invention.

FIG. 2 shows a longitudinal sectional schematic diagram for the structure of the rotor 3 corresponding to said preferable embodiment.

FIG. 3 shows a cross sectional schematic diagram for the assembly of the rotor iron core 31 and the permanent magnets 32 corresponding to the said preferable embodiment.

FIG. 4 shows an A-A sectional view of FIG. 3.

FIG. 5 shows a longitudinal sectional schematic diagram for the rotor iron core 31 corresponding to the said preferable embodiment.

FIG. 6 shows a left view of FIG. 5.

FIG. 7 shows a sectional schematic diagram for the integral structure of the rotor 2 corresponding to the said preferable embodiment.

FIG. 8 shows a left viewed longitudinal sectional schematic diagram of FIG. 7.

FIG. 9 shows a cross sectional schematic diagram for the stator iron core 21.

FIG. 10 shows a left viewed longitudinal sectional schematic diagram of FIG. 9.

FIG. 11 shows a longitudinal sectional schematic diagram for the structure of the first insulation bobbin 23.

FIG. 12 shows a longitudinal sectional schematic diagram for the structure of the stator iron core 21 after two first insulation bobbins 23 are bonded.

FIG. 13 shows a longitudinal sectional schematic diagram for the structure of the second insulation bobbin 24.

FIG. 14 shows a longitudinal sectional schematic diagram for the orthographic projection of the integral structure corresponding to the embodiment that the invention is implemented on the outer rotor electric machine.

In the various figures of the drawings, designations of various numerals are as follows:

1. Shell; 2. Stator; 3. Rotor; 4. End cover; 5. Air gap; 6. Electric machine shaft; 7. Bearing; and 8. Snap ring. In the structure of the stator 2, 21 is the stator iron core, 22 is the stator winding, 23 is the first insulation bobbin, 231 is the (cylindrical) main body, 232 is the ring-shaped radial flange, 24 is the second insulation bobbin, 25 is the metal reinforcing sleeve; and in the structure of the rotor 3, 31 is the rotor iron core, 32 is the permanent magnets, 311 is the axial groove and 312 is the keyway.

In the schematic diagram for the integral structure of the outer rotor electric machine corresponding to FIG. 14, 2′ is the stator, 3′ is the outer rotor, 5′ is the air gap, 6′ is the electric machine bearing shaft, and 7′ is the bearing; in the structure of the stator 2′, 21′ is the stator iron core, 22′ is the stator winding, and 25′ is the metal reinforcing sleeve; and in the structure of the rotor 3′, 31′ is the shell, 32′ is the permanent magnets, 33′ is the right end cover and 34′ is the left end cover.

### MODE OF CARRYING OUT THE INVENTION

Now, further detailed instructions will be made on the invention combining various attached drawings.

According to different forms of the rotor, inner rotor electric machine or outer rotor electric machine may be conceived for the invention.

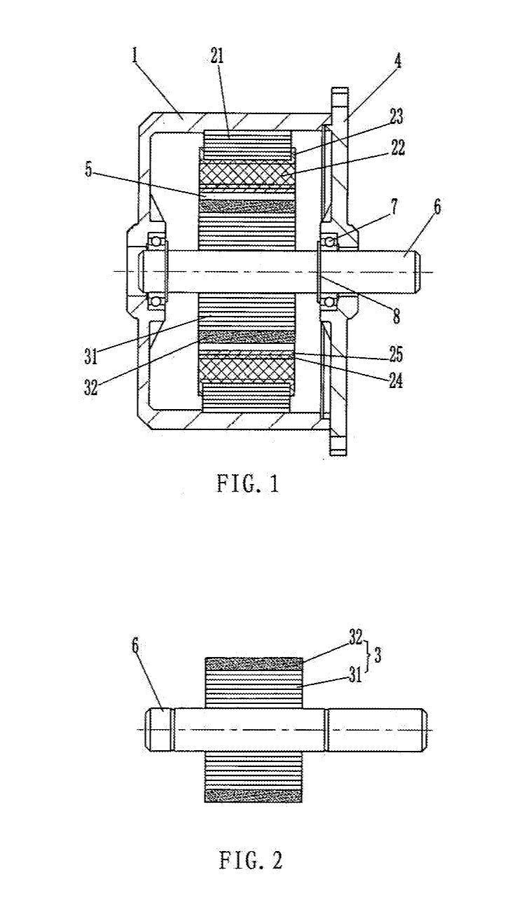

When the invention is embodied in the inner rotor electric machine, see FIG. 1: a slotless amorphous ferroalloy electric machine with radial magnetic circuit comprises: a shell 1, an end cover 4, a stator 2, a rotor 3 and an electric machine shaft 6. The end cover 4 is mounted at the end of the shell 1 and determines the mounting position of the electric machine shaft 6 together with the shell 1. The stator 2 is fixedly mounted inside the shell 1. The rotor 3 is fixedly mounted on the electric machine shaft 6 and arranged inside of the stator 2. A radial gap is arranged between the rotor 3 and the stator 2. The electric machine shaft 6 and the rotor 3 thereon pass through the inner capacity cavity of the stator 2, and rotatably mounted on the mounting position determined by the shell 1 and the end cover 4. For example, the electric machine shaft 6 may be rotatably mounted on the mounting position determined by the shell 1 and the end cover 4 by virtue of two bearings 7. The stator 2 includes the stator iron core 21 and the stator winding 22. The said stator iron core 21 is the cylinder formed by winding an amorphous ferroalloy strip. The said stator winding 22 is integrally in the shape of a cylinder and fixed on the internal cylindrical surface of the stator iron core 21. A metal reinforcing sleeve 25 is fixed on the internal wall of the stator winding 22. The axial length of the metal reinforcing sleeve 25 is identical to that of the stator winding 22. An air gap 5 is formed between the internal cylindrical surface of the metal reinforcing sleeve and the external surface of the said rotor 3.

In the first embodiment of the invention, the stator winding 22 is directly fixed on the internal wall of the said stator iron core 21, and the metal reinforcing sleeve 25 is fixed directly on the internal wall of the stator winding 22.

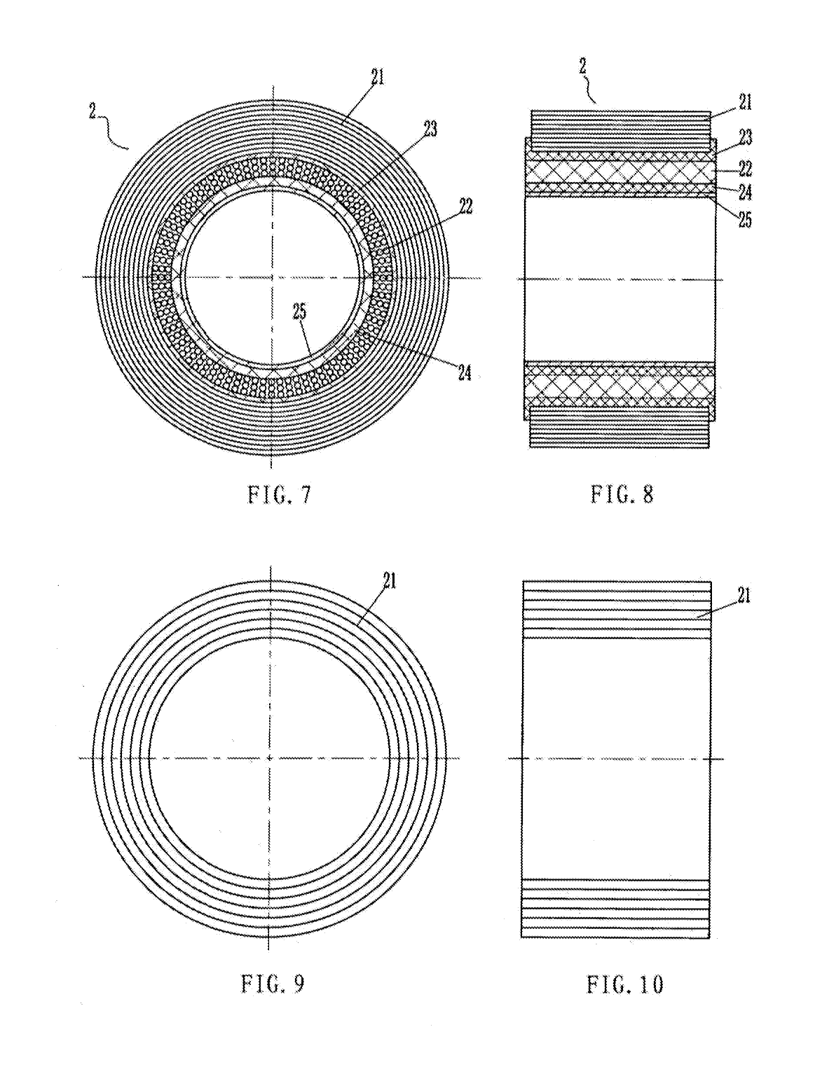

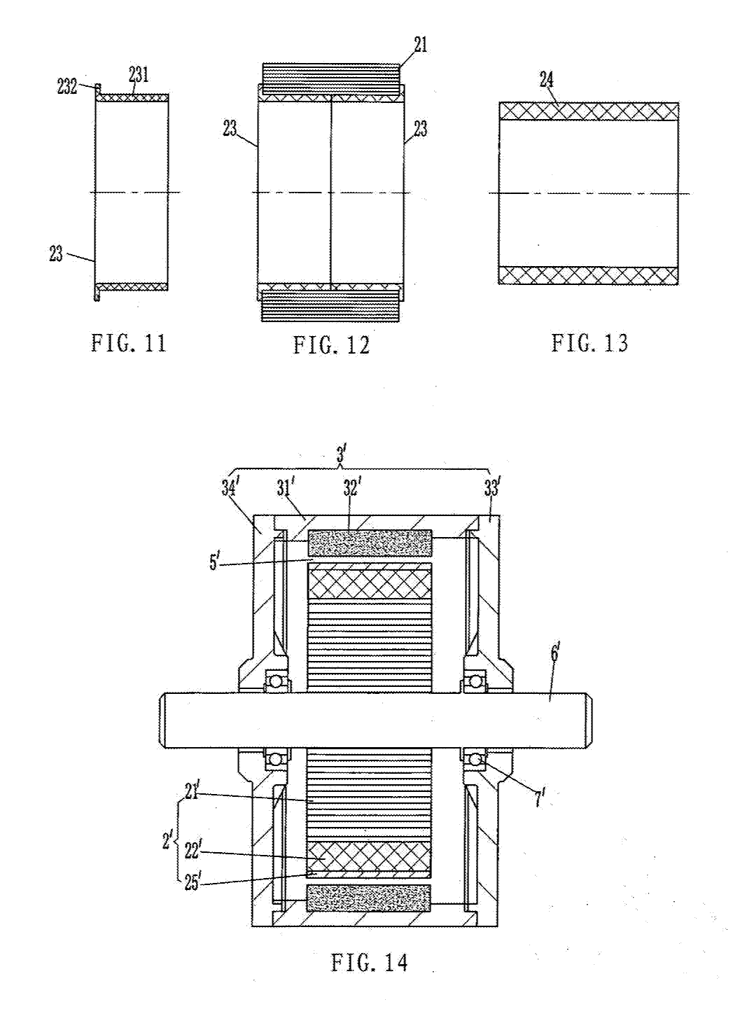

In the second embodiment of the invention, see FIG. 1 and FIG. 7 to FIG. 13, internal wall of the said stator iron core 21 is installed with a first insulation bobbin 23. The main body 231 of the first insulation bobbin 23 is in the shape of a cylinder with one end surface therein set with a ring-shaped radial flange 232. One end which is not set with flange for the two identical first insulation bobbins 23 respectively are embedded from both ends of the inner capacity cavity of the stator iron core 21, butted against each other and fixed on the internal wall of the stator iron core 21. The ring-shaped radial flanges 232 at the end surfaces of the said two first insulation bobbins 23 are tightened against both ends of the inner capacity cavity of the stator iron core 21. The inner cavity of the said stator winding 22 is supported by a cylindrical second insulation bobbin 24 and fixed therein. The axial length of the second insulation bobbin 24 is identical to that of the stator winding 22. The internal wall of the said second insulation bobbin 24 is fixed on the external cylindrical surface of the metal reinforcing sleeve 25.

In the aforementioned various embodiments of the invention, the slotless amorphous ferroalloy electric machine with radial magnetic circuit is the brushless DC electric machine or AC synchronous electric machine, including DC or AC electromotor and generator. Meanwhile, it may also be AC asynchronous electric machine.

See FIG. 1 and FIG. 2, the rotor 3 stated by the invention includes the rotor iron core 31 and the permanent magnets 32. The said rotor iron core 31 may be made by laminating the conventional material, for example the silicon steel stampings; or, as shown by the technical solution of the invention, the said iron core 31 is the hollow structure made from amorphous ferroalloy material, with the radial external surface matched with the permanent magnets 32. The permanent magnets 32 are embedded in or sheathed outside of the external surface of the rotor iron core 31 and fixed. The keyway 312 for connecting with the said electric machine shaft 6 is provided on the inner bore wall of the said rotor iron core 31. The said permanent magnets 32 are neodymium-iron-boron alloy of high density of magnetic energy, or the strontium or barium ferrite.

See FIG. 2, when the permanent magnets 32 are a hollow cylindrical permanent magnetic cylinder with multiple poles formed on the circumferential surface via magnetization, external surface of the section bar blank for the rotor iron core 31 is cylinder, with the outer diameter matched with the inner diameter of cylinder of the permanent magnets. Cylinders of the said permanent magnets are directly sheathed on the rotor iron core 31 and fixed.

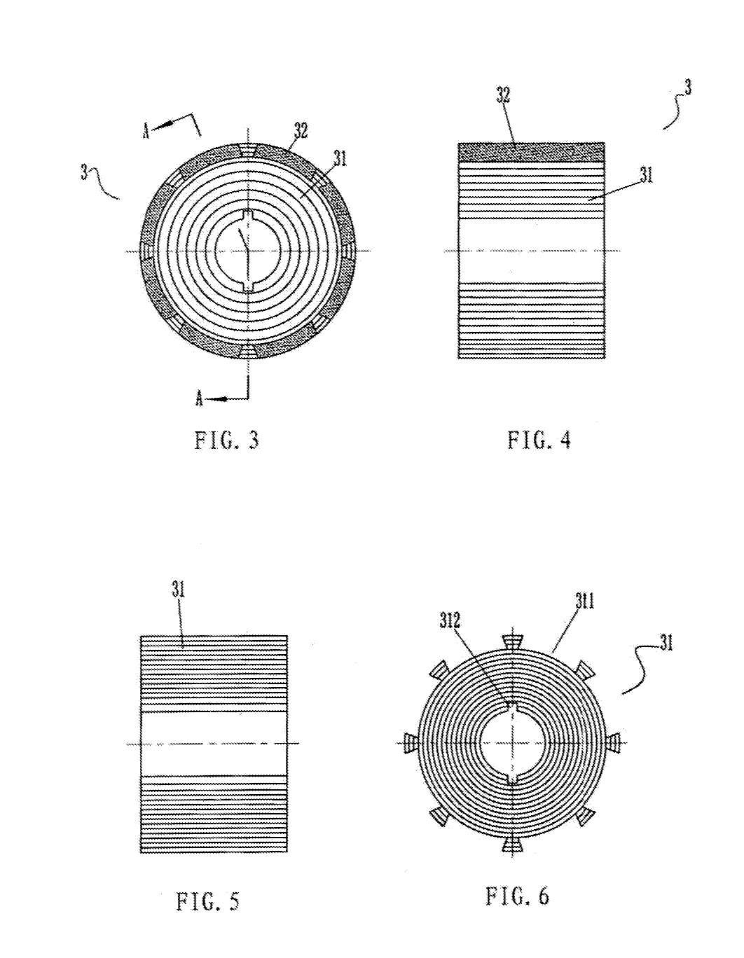

See FIG. 3 to FIG. 6, when the permanent magnets 32 are even-numbered tile-shaped sectional bars or “V” shaped sectional bar solids, the same amount of axial grooves 311 matched with the sectional shapes of all the permanent magnets 32 are provided on the external surface of the rotor iron core 31, and all the permanent magnets 32 shall be embedded into the grooves 311 and fixed. The said axial grooves 311 may be dovetail grooves, and accordingly, the said permanent magnets 32 are with dovetail structures.

Or, when the invention is embodied in the AC asynchronous electric machine, the rotor as stated by the invention includes the rotor iron core 31 and the squirrel-cage thereon. The rotor iron core 31 is sheathed on the electric machine shaft 6. The said squirrel-cage is fixedly mounted on the external surface of the rotor iron core 31. The said rotor iron core 31 may be prepared by laminating conventional materials, for example the silicon steel stampings. Or, as shown by the technical solution of the invention, the said rotor iron core 31 is the hollow cylindrical structure made from amorphous ferroalloy material. The radial external surface of the rotor iron core 31 is matched with the copper or aluminum bar shapes of the said squirrel-cage. The copper bars or aluminum bars are embedded in the external surface of the rotor iron core 31, and fixedly amounted by virtue of the copper or aluminum rings at both ends. Keyway 312 for connecting with the said electric machine shaft 6 is also provided on the inner bore wall of the said rotor iron core 31.

When the invention is embodied in the outer rotor electric machine, see FIG. 14, a slotless amorphous ferroalloy electric machine with radial magnetic circuit includes a stator 2′, an outer rotor 3′ and a electric machine bearing shaft 6′ for mounting. The outer rotor 3′ is arranged outside of the stator 2′, comprising a shell 31′, a left and right end cover 34′ and 33′, and permanent magnets 32′. The permanent magnets 32′ are fixed on the internal wall of the shell 31′, the left and right end covers 34′ and 33′ are fixedly mounted on the left and right end parts of the shell 31′. The outer rotor 3′ is rotatably mounted on the electric machine bearing shaft 6′, for example, the outer rotor 3′ may be mounted on the electric machine bearing shaft 6′ rotatably by virtue of two bearings 7′. The stator 2′ is fixedly mounted on the electric machine bearing shaft 6′, comprising a stator iron core 21′ and a stator winding 22′. The said stator iron core 21′ is the hollow cylindrical structure made from amorphous ferroalloy material. The said stator winding 22′ is integrally in the shape of a cylinder and fixed on the external cylindrical surface of the stator iron core 21′. There is a metal reinforcing sleeve 25′ on the radial external surface of the stator winding 22′. A radial air gap 5′ is formed between the external cylindrical surface of the metal reinforcing sleeve 25′ and the internal surface of the outer rotor 3′. Sheaves of conductive wire led from the stator winding 22′ may be drawn out of the shell 31′ along the surface groove on the electric machine bearing shaft 6′ or along the channel inside the shaft according to the prior art method. The permanent magnets 32′ are embedded in the internal surface of the shell 31′ in the form of even-numbered bars, or directly fixed on the internal surface of the shell 31′ in the hollow cylindrical shape. The shell 31′ is rolled by steel plates or directly made of steel pipes.

In the various embodiments of the invention, the said “fix” refers to the fixation with the adhesives of which the level of resistance to heat are no lower than that of the insulation class for the said electric machine.

Accordingly, the manufacturing method for the slotless amorphous ferroalloy electric machine with radial magnetic circuit is also provided, which includes the steps as follows:
a. Preparation: a hollow cylindrical section bar formed by winding an amorphous ferroalloy strip is used as the blank of the stator iron core 21 and the rotor iron core 31.
b. Elaboration of the stator 2: first, prepare the stator winding 22, then by means of trimming, the required shape and size of the stator winding 22 are obtained. Now, choose to execute one of the following steps:
   b1. If a second insulation bobbin 24 is installed for the stator winding 22, the second insulation bobbin 24 shall be fixed on the internal cylindrical surface of the stator winding 22; then the metal reinforcing sleeve 25 shall be fixed on the internal wall of the second insulation bobbin 24.
   b2. If a second insulation bobbin 24 is not installed for the stator winding 22, then the internal cylindrical surface of the stator winding 22 shall be fixed directly on the metal reinforcing sleeve 25.
Besides, choose to execute one of the following steps again:
   b3. If there is a first insulation bobbin 23 in the stator iron core 21, then the first insulation bobbin 23 shall be fixed on the internal wall of the stator iron core 21, and the external cylindrical surface of the stator winding 22 shall be fixed on the internal wall of the first insulation bobbin 23, thus, the elaboration of stator is completed.
   b4. If the first insulation bobbin 23 is not installed for the stator iron core 21, then the stator winding 22 shall be fixed directly on the internal wall of the stator iron core 21, thus, the elaboration of stator is completed.
c. Elaboration of the rotor 3: keyway 312 used for connecting with the electric machine shaft 6 shall be processed on the inner bore wall of the hollow cylindrical section bar blank which is formed by winding an amorphous ferroalloy strip served as the rotor iron core 31, and choose to execute one of the following steps:
   c1. When the permanent magnets 32 are hollow cylindrical permanent magnetic cylinder with multiple magnetic poles formed on the circumferential surface via magnetization, attributable to the external cylindrical surface of the section bar blank for the rotor iron core 31, the rotor iron core 31 shall be embedded into the cylinder of the said permanent magnets 32 directly and fixed, and then the rotor shall be assembled;
   c2. When the permanent magnets 32 are even-numbered tile-shaped sectional bars or “V” shaped sectional bar solids, the same amount of axial grooves 311 matched with the sectional forms of all the permanent magnets 32 shall be provided on the external surface of the rotor iron core 31, and all the permanent magnets 32 shall be embedded into the axial grooves 311 and fixed. Then, the rotor shall be assembled.
   c3. When the rotor is of squirrel-cage structure, axial grooves which are matched with the axial copper or aluminum bar shapes of the said squirrel-cage shall be processed on the external surface of the rotor iron core 31. Copper or aluminum bars of the squirrel-cage are embedded into the external surface of the rotor iron core 31, fixedly mounted and welded by virtue of the copper or aluminum rings at both ends.
d. Load the stator 2 into the shell 1 and sheath the rotor 3 on the electric machine shaft 6 as per the routine operations, thus, the elaboration of the two components is completed;
e. Complete machine assembly: finish complete machine assembly for the electric machine as per the routine operations.

As another preferable embodiment of the manufacturing method for the invention, it relates to a manufacturing method for the slotless amorphous ferroalloy electric machine with radial magnetic circuit, which includes the steps as follows:
a. Preparation: a hollow cylindrical section bar formed by winding an amorphous ferroalloy strip with respectively satisfactory size is used to serve as the blank of the stator iron core 21 and the rotor iron core 31;
b. Elaboration of stator 2: first, use self-adhesive enameled wire to prepare the stator winding 22 on the winding former, then by trimming with sizing die as well as heating and forming according to the heating standard of the self-adhesive enameled wire, the required cylinder shape and size of the stator winding 22 are obtained. Bond the internal cylindrical surface of the stator winding 22 to the metal reinforcing sleeve 25 with adhesives in the sizing die for solidifying and forming. Then bond the external cylindrical surface of the stator winding 22 to the internal cylindrical surface of the stator iron core 21 with adhesive for solidifying. Then, baking for forming under the condition of 60˜100 for 2-3 h. Thus, elaboration of the stator is completed.
c. Elaboration of the rotor 3: keyway 312 used for connecting with the electric machine shaft 6 shall be processed on the inner bore wall of the hollow cylindrical section bar which is formed by winding an amorphous ferroalloy strip served as the rotor iron core 31, and choose to execute one of the following steps:
   c1. When the permanent magnets 32 are hollow cylindrical permanent magnet cylinder with multiple magnetic poles formed on the circumferential surface via magnetization, external surface of the steel bar blank for the rotor iron core 31 is the cylinder with the outer diameter matched with the inner diameter of the cylinder for the permanent magnets, embed the rotor iron core 31 directly into the said permanent magnet cylinder for bonding and solidifying, assemble the rotor, and bake for forming under the condition of 60-100 for 2-3 h;
   c2. When the permanent magnets 32 are even-numbered tile-shaped sectional bars or “V” shaped sectional bar solids, the same amount axial notches 311 matched with the sectional forms of the permanent magnets 32 shall be provided on the external surface of the rotor iron core 31, embed all the permanent magnets 32 into the axial grooves 311 for fixation, assemble the rotor for baking and forming under the condition of 60-100 for 2-3 h;
   c3. When the rotor is of squirrel-cage structure, axial grooves which are matched with the axial copper or aluminum bar shapes of the said squirrel-cage shall be processed on the external surface of the rotor iron core 31. Copper or aluminum bars of the squirrel-cage are embedded into the external surface of the rotor iron core 31, fixedly mounted and welded by virtue of the copper or aluminum rings at both ends, then, assemble the rotor;
d. Load the stator 2 into the shell 1 and sheath the rotor 3 onto the electric machine shaft 6 as per the routine operations, thus, the elaboration of the two components is completed;
e. Complete machine assembly: finish complete machine assembly for the electric machine as per the routine operations.

As yet another preferable embodiment of the manufacturing method for the present invention, it relates to a manufacturing method for the slotless amorphous ferroalloy electric machine with radial magnetic circuit, which includes the steps as follows:
a. Preparation: a hollow cylindrical section bar formed by winding an amorphous ferroalloy strip commercially available and satisfactory in size respectively is used as the blank of the stator iron core 21 and the rotor iron core 31;
b. Elaboration of the stator 2: first of all, prepare the stator winding 22 with self-adhesive enameled wire on the winding former, then, by trimming with a sizing die and heating and forming according to the heating standard of the self-adhesive enameled wire, the required cylinder shape and size of the stator winding 22 are obtained. Then, bond the second insulation bobbin 24 in the sizing die to the internal cylindrical surface of the stator winding 22 with adhesive for solidifying and forming, and bond the metal reinforcing sleeve 25 in the sizing die to the internal wall of the second insulation bobbin 24 with adhesives for solidifying and forming, next, one end which is not set with flange 232 for the two identical first insulation bobbins 23 respectively are embedded from both ends of the inner capacity cavity of the stator iron core 21, butted against each other, bonded and fixed to the internal wall of the stator iron core 21 with adhesives for forming. The ring flanges 232 at the end faces of the said two first insulation bobbins 23 are tightened against both ends of the inner capacity cavity of the stator iron core 21. Bond and solidify the stator winding package 22, 24 & 25 manufactured as per the above steps onto the two first insulation bobbin 23 on the internal wall of the said stator iron core 21 with adhesives. Finally, bake the complete stator 2 under the condition of 60-100 for 2-3 h for forming, thus the elaboration of the stator is completed;
c. Elaboration of the rotor 3: keyway 312 used for connecting with the electric machine shaft 6 shall be processed on the inner bore wall of the hollow cylindrical section bar blank which is formed by winding an amorphous ferroalloy strip served as the rotor iron core 31, and choose to execute one of the following steps:
   c1. When the permanent magnets 32 are hollow cylindrical permanent magnet cylinder with multiple magnetic poles formed on the cylindrical surface via magnetization, external surface of the steel bar blank for the rotor iron core 31 is cylinder with the outer diameter matched with the inner diameter of the cylinder for the permanent magnets, embed the rotor iron core 31 directly into the said permanent magnet cylinder for bonding and solidifying, assemble the rotor, and bake for forming under the condition of 60-100 for 2-3 h;
   c2. When the permanent magnets 32 are even-numbered tile-shaper sectional bars or “V” shaped sectional bar solids, the same amount axial notches 311 matched with the sectional forms of the permanent magnets 32 shall be provided on the external surface of the rotor iron core 31, embed all the permanent magnets 32 into these axial notches 311 for splicing and solidification, assemble the rotor for baking and forming under the condition of 60-100 for 2-3 h;
   c3. When the rotor is of squirrel-cage structure, axial grooves which are matched with the axial copper or aluminum bar shapes of the said squirrel-cage shall be processed on the external surface of the rotor iron core 31. Copper or aluminum bars of the squirrel-cage are embedded into the external surface of the rotor iron core 31, fixedly mounted by virtue of the copper or aluminum rings at both ends, then, assemble the rotor.
d. Load the stator 2 into the shell 1 and sheath the rotor 3 onto the electric machine shaft 6 as per the routine operations, thus, the elaboration of the two components is completed;
e. Complete machine assembly: finish complete machine assembly for the electric machine as per the routine operations.

For the outer rotor electric machine, manufacturing method for the slotless amorphous ferroalloy outer rotor electric machine with radial magnetic circuit is also provided accordingly, which includes the steps as follows:
a. Preparation: a hollow cylindrical section bar formed by winding an amorphous ferroalloy strip is used as the blank of the stator iron core 21;
b. Elaboration of stator: keyway used for connecting the electric machine shaft shall be processed on the inner bore surface of the stator iron core 21′, prepare the stator winding 22′, then by means of trimming, the required shape and size of the stator winding 22′ are obtained. The external cylindrical surface of the stator winding 22′ shall be fixed directly into the metal reinforcing sleeve 25′. The stator winding 22′ shall be sheathed and fixed on the external cylindrical surface of the stator iron core 21′. The stator iron core 21′ and the electric machine shaft 6′ shall be connected and fixed with keys, and two bearings 7′ shall be mounted for the electric machine baring shaft 6′, thus the elaboration of the stator is completed.
c. Elaboration of rotor: even-numbered bars or hollow cylindrical permanent magnets 32′ shall be made. Roll the steel plate into shell 31′ or use the steel pipe directly as the shell 31′. Shapes matched with the permanent magnets 32′ to be fixed shall be processed on the internal wall of the shell 31′. Permanent magnets 32′ shall be embedded into and fixed on the internal wall of the shell 31′, and the rotor shall be assembled.
d. Finish complete machine assembly for the electric machine as per the routine operations.

In various embodiments of the present invention, the amorphous ferroalloy material used by the said stator iron core 21 and rotor iron core 31 adopts the section bar and section bar blank, which is manufactured by winding the nanosized iron-based amorphous ferroalloy strip produced by Advanced Technology & Materials Co., Ltd., People's Republic of China.

In various embodiments of the present invention, adhesives for bonding all components of the said stator 2 as well as for bonding the rotor iron core 31 to the permanent magnets 32 are the adhesives with level of resistance to heat no lower than that of the insulation class for the said electric machine. In various embodiments of the invention, the ESP110 resin produced by Henkel Corporation (U.S.A.) and two-component 3034A & 3034B epoxy resin of high-strength, resistance to high-temperature 200° C., manufactured by Langbowan Company are adopted. And the adhesive operations are executed as per requirements by the prior art related to adhesives.

The above-mentioned embodiments are specifically described in detail by means of only expressing the preferable executive methods of the present invention, which shall not thereby be understood as limitations to the scope of the said invention patent; it shall be noted by ordinary technicians in the art that several variations and improvements can be made without departing from the conception of the present invention, which are included within the protection scope therein; therefore, any and all equivalent alterations and modifications made within the scope of claims of the present invention are covered by the claims of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A slotless amorphous ferroalloy electric machine with radial magnetic circuit, comprising: a shell, an end cover, a stator, a rotor and a electric machine shaft; the end cover is mounted to the end of the shell and determines the mounting position of the electric machine shaft together with the shell; the stator is fixedly mounted to the inside of the shell; the rotor is fixedly mounted onto the electric machine shaft and arranged inside of the stator; a radial air gap is arranged between the rotor and the stator; the electric machine shaft and the rotor thereon pass through the internal capacity cavity of the stator, rotatably mounted to the mounting positions determined by the shell and the end cover; the stator consists of a stator iron core and a stator winding;
The said stator iron core is a cylinder formed by winding an amorphous ferroalloy strip; the internal wall of the said stator iron core is installed with first insulation bobbins; the main body of the first insulation bobbin is in the shape of a cylinder with one end surface therein fixed with a ring-shaped radial flange; but the another ends which are not set with flanges for the two identical first insulation bobbins respectively are embedded from both ends of the inner capacity cavity of the stator iron core, butted against each other and fixed to the internal wall of the stator iron core; the ring-shaped radial flanges at the end surfaces of the said two first insulation bobbins are tightened against both ends of the inner capacity cavity of the stator iron core;
the said stator winding is integrally in the shape of a cylinder and fixed on the internal cylindrical surface of the first insulation bobbins; a metal reinforcing sleeve is fixed on the internal surface of the stator winding; the axial length of the metal reinforcing sleeve is identical to that of the stator winding; a radial air gap is arranged between the internal cylindrical surface of the metal reinforcing sleeve and the external surface of the said rotor.

16. The slotless amorphous ferroalloy electric machine with radial magnetic circuit as stated in claim 15, wherein
the said rotor consists of a rotor iron core and permanent magnets; the said rotor iron core is a hollow cylindrical structure made of amorphous ferroalloy material; the radial external surface of the rotor iron core is matched with the permanent magnets; the permanent magnets are embedded on or sheathed outside of the external surface of the rotor iron core and fixed thereon.

17. The slotless amorphous ferroalloy electric machine with radial magnetic circuit as stated in claim 15, wherein
the said rotor includes a rotor iron core and a Squirrel-cage on its surface; the rotor iron core is sheathed onto the electric machine shaft; the said Squirrel-cage is fixedly mounted onto the external surface of the rotor iron core, assembled into an AC asynchronous machine; the said rotor iron core is a hollow cylindrical structure made of amorphous ferroalloy material, whose radial external surface is matched with the shape of the axial copper bar or aluminum bar of the said Squirrel-cage; the copper bars or aluminum bars are embedded in the external surface of the rotor iron core and fixedly mounted by virtue of the copper rings or aluminum rings at both ends.

18. The slotless amorphous ferroalloy electric machine with radial magnetic circuit as stated in claims 15 to 17, wherein
the inner cavity of the said stator winding is supported by a cylinder-shaped second insulation bobbin and fixed therein; the axial length of the second insulation bobbin is identical to that of the stator winding; the internal wall of the said second insulation bobbin is fixed on the external cylindrical surface of the metal reinforcing sleeve.

19. A manufacturing method for a slotless amorphous ferroalloy electric machine with radial magnetic circuit, comprising the steps as follows:
a. Preparation: a hollow cylindrical section bar formed by winding an amorphous ferroalloy strip is used as the blank of the stator iron core and the rotor iron core;
b. Elaboration of the stator: first, prepare the stator winding, then by means of trimming, the required shape and size of the stator winding are obtained; now, choose to execute one of the following steps:
b1. If a second insulation bobbin is installed for the stator winding, the second insulation bobbin shall be fixed on the internal cylindrical surface of the stator winding; then the metal reinforcing sleeve shall be fixed on the internal wall of the second insulation bobbin;
b2. If a second insulation bobbin is not installed for the stator winding, then the internal cylindrical surface of the stator winding shall be fixed directly on the metal reinforcing sleeve;
Besides, choose to execute one of the following steps again:
b3. If there is a first insulation bobbin in the stator iron core, then the first insulation bobbin shall be fixed on the internal wall of the stator iron core, and the external cylindrical surface of the stator winding shall be fixed on the internal wall of the first insulation bobbin, thus, the elaboration of stator is completed;
b4. If the first insulation bobbin is not installed for the stator iron core, then the stator winding shall be fixed directly on the internal wall of the stator iron core, thus, the elaboration of stator is completed;
c. Elaboration of the rotor: keyway used for connecting with the electric machine shaft shall be processed on the inner bore wall of the hollow cylindrical section bar which is formed by winding an amorphous ferroalloy strip served as the blank of the rotor iron core, and choose to execute one of the following steps:
c1. When permanent magnets are hollow cylindrical permanent magnetic cylinder with multiple magnetic poles formed on the circumferential surface via magnetization, attributable to the external cylindrical surface of the section bar blank for the rotor iron core, the rotor iron core shall be embedded into the cylinder of the said permanent magnets directly and fixed, and then the rotor shall be assembled;
c2. When permanent magnets are even-numbered tile-shaped sectional bar or “V”-shape sectional bar solids, the same amount of axial grooves shall be provided which are matched with the sectional forms of all permanent magnets on the external surface of the rotor iron core, all permanent magnets shall be embedded into the axial grooves and fixed, then, the rotor shall be assembled;
c3. When the rotor is of Squirrel-cage structure, axial grooves which are matched with the axial copper or aluminum bar shapes of the said Squirrel-cage shall be processed on the external surface of the rotor iron core; copper or aluminum bars of the Squirrel-cage are embedded into the external surface of the rotor iron core, fixedly mounted by virtue of the copper or aluminum rings at both ends;
d. Load the stator into the shell and sheath the rotor onto the electric machine shaft as per the routine operations, thus, the elaboration of the two components is completed;
e. Complete machine assembly: finish complete machine assembly for the electric machine as per the routine operations.

20. A manufacturing method for the slotless amorphous ferroalloy electric machine with radial magnetic circuit, comprising the steps as follows:
a. Preparation: a hollow cylindrical section bar formed by winding an amorphous ferroalloy strip is used as the blank of the stator iron core;
b. Elaboration of stator: keyway used for connecting the electric machine shaft shall be processed on the inner bore surface of the stator iron core, stator winding shall be prepared, then by means of trimming, the required shape and size of the stator winding are obtained; the external cylindrical surface of the stator winding shall be fixed directly into the metal reinforcing sleeve; the stator winding shall be sheathed and fixed on the external cylindrical surface of the stator iron core; the stator iron core and the electric machine shaft shall be connected and fixed with keys, and two bearings shall be mounted for the electric machine baring shaft, thus the elaboration of the stator is completed;
c. Elaboration of rotor: even-numbered bars or hollow cylindrical permanent magnets shall be made; roll the steel plate into shell or use the steel pipe directly as the shell; shapes matched with the to-be-fixed permanent magnets shall be processed on the internal wall of the shell; permanent magnets shall be embedded into and fastened with the internal wall of the shell, and the rotor shall be assembled;
d. Finish complete machine assembly for the electric machine as per the routine operations.

21. A manufacturing method for the slotless amorphous ferroalloy electric machine with radial magnetic circuit, comprising the steps as follows:
a. Preparation: a hollow cylindrical section bar formed by winding an amorphous ferroalloy strip with respectively satisfactory size is used as the blank of the stator iron core and the rotor iron core;
b. Elaboration of the stator: first of all, use self-adhesive enameled wire to prepare the stator winding on the winding former, then by trimming with sizing die as well as heating and forming according to the heating standard of the self-adhesive enameled wire, the required cylindrical shape and size of the stator winding are obtained; bond the internal cylindrical surface of the stator winding to the metal reinforcing sleeve with adhesives in the sizing die for solidifying and forming; then bond the external cylindrical surface of the stator winding to the internal cylindrical surface of the stator iron core with adhesives for solidifying; then, baking and forming under the condition of 60˜100 for 2-3 h. Thus, elaboration of the stator is completed;
c. Elaboration of the rotor: keyway used for connecting with the electric machine shaft shall be processed on the inner bore wall of the hollow cylindrical section bar which is formed by winding an amorphous ferroalloy strip served as the rotor iron core, and choose to execute one of the following steps:
c1. When the permanent magnets are hollow cylindrical permanent magnet cylinder with multiple magnetic poles formed on the circumferential surface via magnetization, external surface of the section bar blank for the rotor iron core is cylinder with the outer diameter matched with the inner diameter of the cylinder for the permanent magnets, embed the rotor iron core directly into the said permanent magnet cylinder for bonding and solidifying, assemble the rotor, and bake for forming under the condition of 60˜100 for 2˜3 h;
c2. When the permanent magnets are even-numbered tile-shaped sectional bars or “V” shaped sectional bar solids, the same amount axial grooves matched with the sectional forms of the permanent magnets shall be provided on the external surface of the rotor iron core, embed all the permanent magnets into the axial grooves for fixation, assemble the rotor for baking and forming under the condition of 60˜100 for 2˜3 h;
c3. When the rotor is of squirrel-cage structure, axial grooves which are matched with the axial copper or aluminum bar shapes of the said squirrel-cage shall be processed on the external surface of the rotor iron core; copper or aluminum bars of the squirrel-cage are embedded into the external surface of the rotor iron core, fixedly mounted by virtue of the copper or aluminum rings at both ends, then, assemble the rotor;
d. Load the stator into the shell and sheath the rotor onto the electric machine shaft as per the routine operations, thus, the elaboration of the two components is completed;
e. Complete machine assembly: finish complete machine assembly for the electric machine as per the routine operations.

22. A manufacturing method for the slotless amorphous ferroalloy electric machine with radial magnetic circuit as stated in claim 21, wherein
The adhesives used for bonding all components in the said stator as well as for bonding the rotor iron core with the permanent magnets are the adhesives with level of resistance to heat no lower than that of the insulation class for the said electric machine.

23. A manufacturing method for the slotless amorphous ferroalloy electric machine with radial magnetic circuit, comprising the steps as follows:
a. Preparation: a hollow cylindrical section bar formed by winding an amorphous ferroalloy strip commercially available and satisfactory in size respectively is used as the blank of the stator iron core and the rotor iron core;
b. Elaboration of the stator: first of all, prepare the stator winding with self-adhesive enameled wire on the winding former, then, by trimming with a sizing die and heating and forming according to the heating standard of the self-adhesive enameled wire, the required cylindrical shape and size of the stator winding are obtained; then, bond the second insulation bobbin in the sizing die to the internal cylindrical surface of the stator winding with adhesives for solidifying and forming, and bond the metal reinforcing sleeve in the sizing die to the internal wall of the second insulation bobbin with adhesives for solidifying and forming, next, one end which is not set with flange for the two identical first insulation bobbins respectively are embedded from both ends of the inner capacity cavity of the stator iron core, butted against each other, bonded and fixed to the internal wall of the stator iron core with adhesives for forming; the ring flanges at the end faces of the said two first insulation bobbins are tightened against both ends of the inner capacity cavity of the stator iron core; bond and solidify the stator winding package manufactured as per the above steps onto the two first insulation bobbin on the internal wall of the said stator iron core with the adhesive; finally, bake the complete stator under the condition of 60˜100 for 2˜3 h for forming, thus the elaboration of the stator is completed;
c. Elaboration of the rotor: keyway used for connecting with the electric machine shaft shall be processed on the internal wall of the hollow cylindrical section bar which is formed by winding an amorphous ferroalloy strip used to serve as the blank for the rotor iron core, and choose to execute one of the following steps:
c1. When the permanent magnets are hollow cylindrical permanent magnet cylinder with multiple magnetic poles formed on the cylindrical surface via magnetization, external surface of the section bar blank for the rotor iron core is the cylinder with the outer diameter matched with the inner diameter of the cylinder for the permanent magnets, embed the rotor iron core directly into the said permanent magnet cylinder for bonding and solidifying, assemble the rotor, and bake for forming under the condition of 60˜100 for 2˜3 h;
c2. When the permanent magnets are even-numbered tile-shaped sectional bars or “V” shaped sectional bar solids, the same amount axial grooves matched with the sectional forms of the permanent magnets shall be provided on the external surface of the rotor iron core, embed all the permanent magnets into these axial grooves for bonding and solidifying, assemble the rotor for baking and forming under the condition of 60˜100 for 2˜3 h;
c3. When the rotor is of squirrel-cage structure, axial grooves which are matched with the axial copper or aluminum bar shapes of the said squirrel-cage shall be processed on the external surface of the rotor iron core; copper or aluminum bars of the squirrel-cage are embedded into the external surface of the rotor iron core, fixedly mounted by virtue of the copper or aluminum rings at both ends, then, assemble the rotor;
d. Load the stator into the shell and sheath the rotor onto the electric machine shaft as per the routine operations, thus, the elaboration of the two components is completed;
e. Complete machine assembly: finish complete machine assembly for the electric machine as per the routine operations.

24. A manufacturing method for the slotless amorphous ferroalloy electric machine with radial magnetic circuit as stated in claim 23, wherein
The adhesives for bonding all components of the said stator as well as for bonding the rotor iron core with the permanent magnets are the adhesives with level of resistance to heat no lower than that of the insulation class for the said electric machine.
